(19) United States
(12) Patent Application Publication
(10) Pub. No.: US 2001/0041021 A1
(43) Pub. Date: Nov. 15, 2001

(54) System and method for synchronization of image data between a handheld device and a computer

(76) Inventors: Dennis J. Boyle, Palo Alto, CA (US); Edward S. Kirk, Palo Alto, CA (US)

Correspondence Address: CARR & FERRELL LLP, 2225 EAST BAYSHORE ROAD, SUITE 200, PALO ALTO, CA, 94303, US

(21) Appl. No.: 09/775,470

(22) Filed: Feb. 2, 2001

Related U.S. Application Data
(60) Provisional application No. 60/180,380, filed on Feb. 4, 2000.

(51) Int. Cl. G06K 9/54

(52) U.S. Cl. 382/305

(57) ABSTRACT

A system and method providing a conduit (310) between a handheld electronic device (120), such as a personal digital assistant (PDA) and a remote storage unit (110), such as a personal computer (PC) hard drive, allowing a user to transfer images captured by an image capture device (124) attached to the handheld electronic device (120) and synchronize the data between the handheld electronic device (120) and the remote storage unit (110) in a manner that is easy, intuitive and useful, is disclosed.

In its preferred embodiment, the conduit (310) of the present invention is a software program that is installed into the standard sync manager (230) of a computer, providing seamless synchronization between a PDA and the computer without the need for user interaction.

### CROSS-REFERENCES TO RELATED APPLICATIONS

This application claims the benefit of Provisional Patent Application Serial No. 60/180,380, filed on Feb. 4, 2000, entitled “System And Method For Synchronization Of Image Data Between A Computer And A Handheld Device,” which is incorporated herein by reference.

### BACKGROUND OF THE INVENTION

1. Field of the Invention

This invention relates generally to interfaces with handheld electronic devices and relates more particularly to a system and method for synchronization of image data between a handheld device and a computer.

2. Description of Related Art

Handheld electronic devices such as personal data assistants (PDAs) are becoming increasingly popular as a convenient way to capture and store information. These devices become even more useful when they are able to exchange information with other electronic devices, especially computers. A user may thus enter information, such as an appointment or telephone number, into a handheld device and, by connecting the handheld device to a computer, may transfer the entered information to the computer. Used in this way, the user does not have to enter the information more than once in order to utilize that information in more than one device. Consequently, efficient synchronization of data between computers and handheld electronic devices is an important consideration of designers and manufacturers of electronic systems.

As a result of the increasing popularity of PDAs and other similar handheld electronic devices, the industry is experiencing an equivalent growth in the market and demand for peripheral devices that can be attached to the handheld electronic device to enhance its capabilities. One such module is a digital camera, which can be attached to the handheld electronic device to turn the device into a virtual camera. These devices have the capability to allow the user to capture and store images onto the electronic device for later retrieval and viewing.

As the technology of handheld electronic devices advances, users will require a method to transmit these captured images to other devices, such as a personal computer or other storage device. Because of the decreasing size and increasing power and complexity of such handheld devices, it is important to the user to be able to transmit images with as little user intervention as possible and without cumbersome hardware and/or complex software.

Therefore, a current need exists for a fast and user-friendly conduit for use between a handheld electronic device and a remote storage device to transfer images and other such data and a method for transferring and synchronizing the same.

### SUMMARY OF THE INVENTION

The present invention provides a system and method for transferring and synchronizing data from an electronic device to a remote storage device in a manner that is easy, intuitive and useful. Specifically, the present invention is a system and method providing a conduit between a handheld electronic device, such as a personal digital assistant (PDA) and a remote storage unit, such as a personal computer (PC) hard drive, that allows a user to transfer images captured by an image capture device attached to the electronic device and synchronize the data between the electronic device and the storage unit.

In a preferred embodiment, the conduit of the present invention is a software program that is installed into the standard “HotSync” manager of the PC, providing seamless synchronization between the PDA and the PC without the need for user interaction. Other advantages, features and embodiments of the present invention will be apparent from the drawings and detailed description as set forth below.

### BRIEF DESCRIPTION OF THE DRAWINGS

FIG. 1 is a plan view of a personal computing device and a handheld electronic device, according to one embodiment of the present invention;

FIG. 2 is a block diagram of one embodiment of the computing device of FIG. 1, according to the present invention;

FIG. 3 is a block diagram for one embodiment of the sync manager of FIG. 2, according to the present invention;

FIG. 4 is a block diagram of one embodiment of the handheld electronic device of FIG. 1, according to the present invention;

FIG. 5 is a block diagram of one embodiment of the captured image data of FIG. 4, according to the present invention;

FIG. 6 is a flowchart of method steps for capturing and transferring images from a handheld electronic device, according to one embodiment of the present invention; and

FIG. 7 is a flowchart of method steps for seamlessly transferring images from a handheld electronic device, according to one embodiment of the present invention.

### DESCRIPTION OF THE PREFERRED EMBODIMENTS

The present invention relates to an improvement in interfaces with handheld electronic devices. The following description is presented to enable one of ordinary skill in the art to make and use the invention and is provided in the context of a patent application and its requirements. Various modifications to the preferred embodiment will be readily apparent to those skilled in the art and the generic principles herein may be applied to other embodiments. Thus, the present invention is not intended to be limited to the embodiment shown but is to be accorded the widest scope consistent with the principles and features described herein.

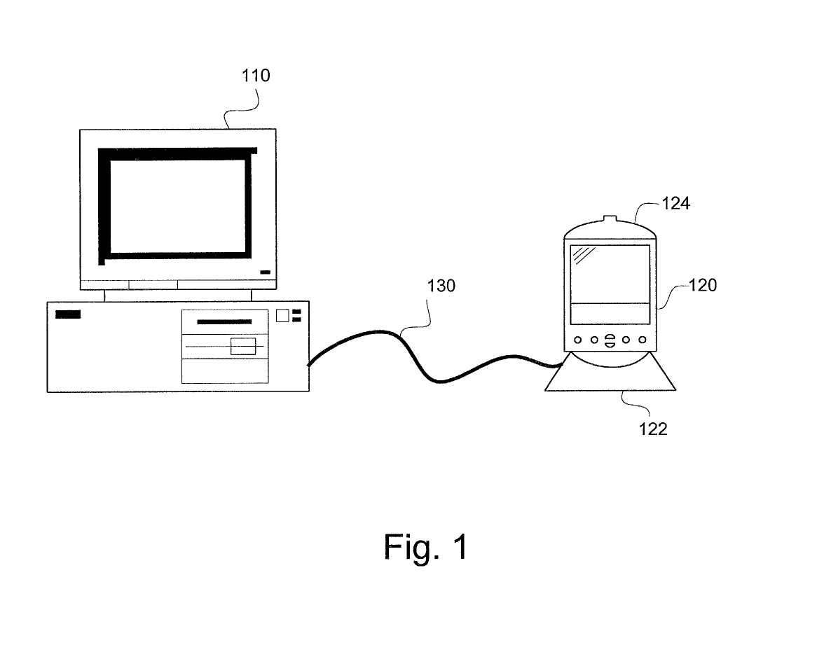

Referring now to FIG. 1, a plan view of a computing device 110 and a handheld electronic device 120 is shown, according to one embodiment of the present invention. The handheld electronic device 120 is docked in an input output (I/O device 122, which is connected to the computing device 110 via a connection 130. An image capture device 124 is coupled to the handheld electronic device 120. Images captured by the image capture device 124 are stored in the handheld electronic device 120.

The connection 130 allows the handheld electronic device 120 and the computing device 110 to synchronize (sync) or share data. The connection 130 may be implemented using any appropriate connectivity configuration, such as serial bus and Universal Serial Bus (USB). Although a hardwired connection is shown in FIG. 1, a wireless connection, such as infrared, is within the scope of the present invention. The manufacturer of the handheld electronic device 120 typically determines the configuration of the connection 130. Data from the computing device 110 may be stored in the handheld electronic device 120, and data from the handheld electronic device 120 may be stored in the computing device 110. Applications in the computing device 110, known as conduits, allow for data to be exchanged without user interaction.

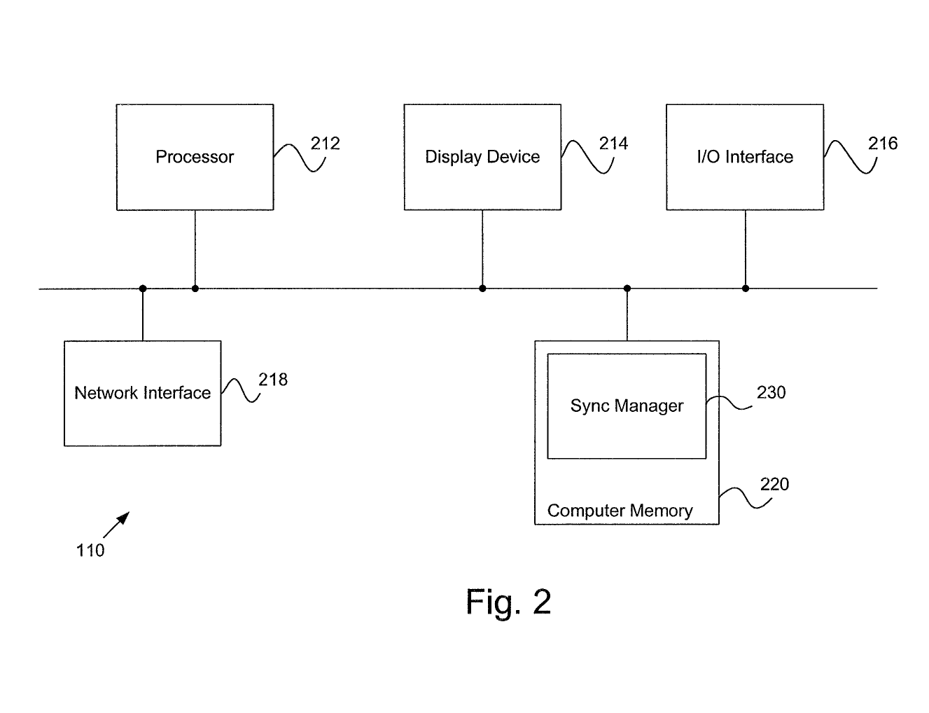

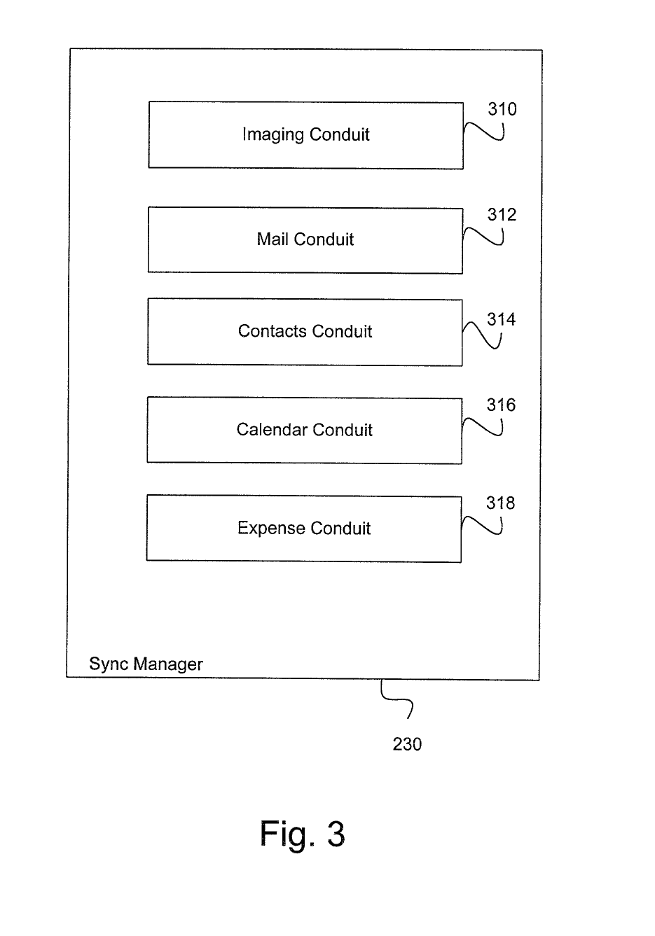

Referring now to FIG. 2, a block diagram of one embodiment of the computing device 110 of FIG. 1 is shown, according to the present invention. The computing device 110 includes, but is not limited to, a processor 212, a display device 214, an input/output (I/O) interface 216, a network interface 218, and a computer memory 220. The computer memory 220 includes, but is not limited to, a sync manager 230, which is discussed below in conjunction with FIG. 3.

The I/O interface 216 allows the computing device 110 to communicate with the handheld electronic device 120 via the connection 130 using any appropriate connectivity configuration. The network device 218 allows the computing device 110 to exchange data with a network (not shown) via any appropriate network connectivity configuration.

Referring now to FIG. 3, a block diagram of one embodiment of the sync manager 230 of FIG. 2 is shown, according to the present invention. The sync manager 230 includes, but is not limited to, an imaging conduit 310, a mail conduit 312, a contacts conduit 314, a calendar conduit 316, and an expense conduit 318. Each conduit in the sync manager 230 controls the exchange of particular types of data between the computing device 110 and the handheld electronic device 120.

The sync manager 230 copies all the data in the handheld electronic device 120 and stores the data in one location of the computing device 110 to create a backup for the handheld electronic device 120. Thus, if all data is lost from the handheld electronic device 120, the backup data may be reinstalled from the computing device 110 to the handheld electronic device 120. The sync manager 230 also provides the user the capability to change the data on one device, the handheld electronic device 120 for example, and subsequently synchronize the changed data with data located on the computing device 110. To accomplish this, the various conduits are run by the sync manager 230 to seek out specific data for synchronization. For example, the contacts conduit 314 will seek out contact data in the handheld electronic device 120, and then will copy any updated data, e.g., a new address, to the computing device 110. Likewise, the contacts conduit 314 will seek out contact data in the computing device 110 and copy any updated data to the handheld electronic device 120. The sync manager 230 thereby assures the user that only the latest data located on either device will be synchronized with the other and all information is current and up-to-date.

The sync manager 230 runs the imaging conduit 310 to seek out image data in the handheld electronic device 120. The imaging conduit 310 queries records stored in various databases in the handheld electronic device 120 for image data. The imaging conduit 310 transfers image data from the handheld electronic device 120 and stores the images in the computer memory 220 of the computing device 110 (FIG. 2).

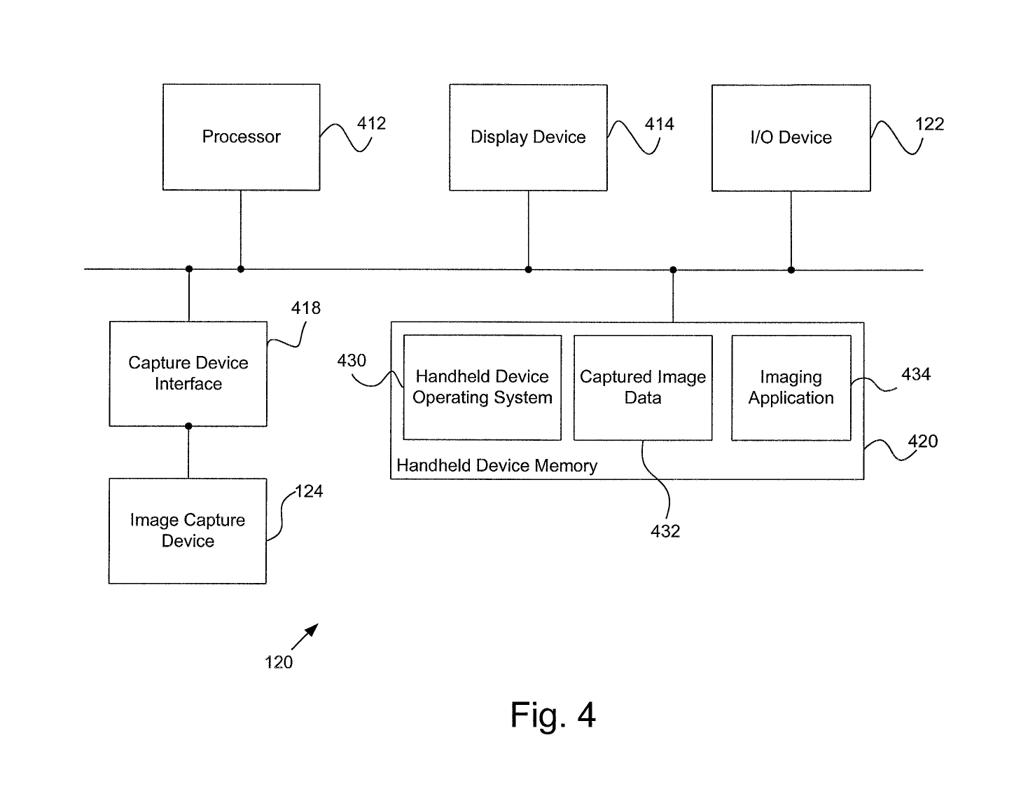

Referring now to FIG. 4, a block diagram of one embodiment of the handheld electronic device 120 of FIG. 1 is shown, according to the present invention. The handheld electronic device 120 includes, but is not limited to, a processor 412, a display device 414, the I/O device 122 of FIG. 1, a capture device interface 418 coupled to the image capture device 124 of FIG. 1, and a handheld device memory 420. The handheld device memory 420 includes, but is not limited to, a handheld device operating system 430, captured image data 432, and an imaging application 434.

In one embodiment, the I/O device 122 is a cradle with a hardwire connection to the computing device 110. In another embodiment, the I/O device 122 is integral with the handheld electronic device 120. An example of the capture device interface 418 is the SPRINGBOARD™ expansion slot available on the VISOR™ PDA manufactured by Handspring, Inc. In the preferred embodiment, the image capture device 124 is a digital camera, such as the EYEMODULE™, manufactured by IDEO Product Development Inc.

The image capture device 124 captures images under the control of the imaging application 434. A captured image is displayed on the display device 414 via the capture device interface 418. A user can determine whether the image capture device 124 captures images as a gray scale (black and white) image or a color image. Since the display device 414 typically only displays gray scale images, a gray scale image is usually captured by the image capture device 124 for display on the handheld electronic device 120. The user may also choose between a high-resolution gray scale image and a low-resolution gray scale image.

Captured images may be stored in the captured image data 432. If the user chooses to capture a color image, the color version and the gray scale version of the image will be stored in the captured image data 432. The imaging application 434 may prompt the user to name the image, and to supply a text annotation to the image if desired. If no name is specified, the imaging application 434 uses a time/date stamp as the name of the image.

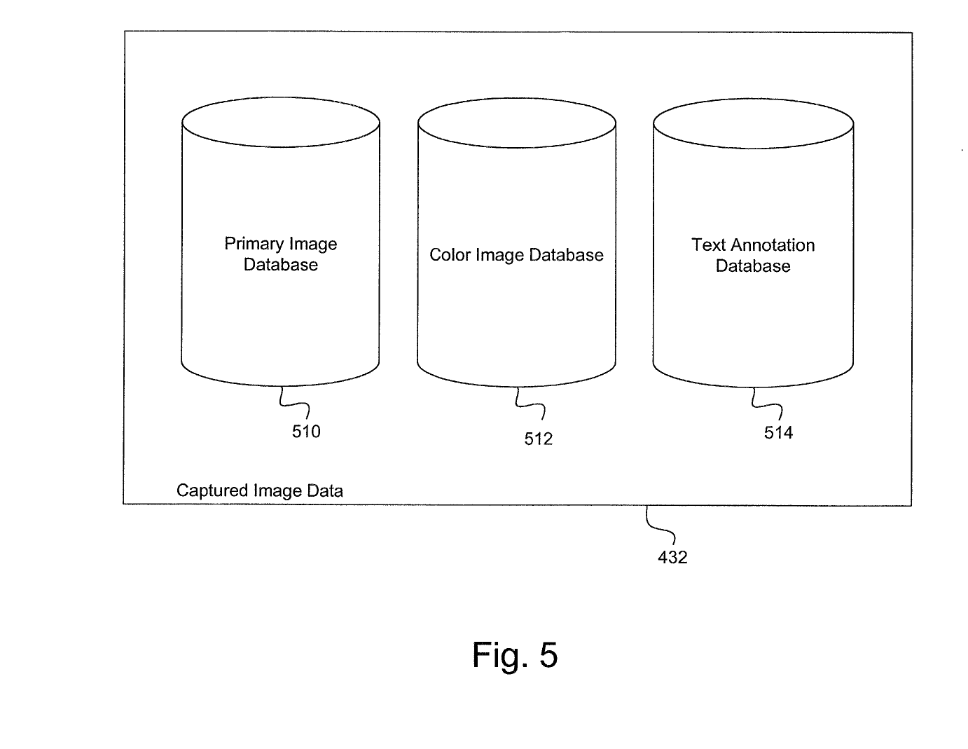

Referring now to FIG. 5, a block diagram of one embodiment of the captured image data 432 of FIG. 4 is shown, according to the present invention. The captured image data 432 includes, but is not limited to, a primary image database 510, a color image database 512, and a text annotation database 514. The primary image database 510 includes category, name, size, and gray scale data for each captured image. Each image record in the primary image database 510 also has a flag that indicates whether a corresponding color image exists and whether a corresponding text annotation exists. If a corresponding color image exists, the primary image database 510 contains a pointer to the location of the color image in the color image database 512. If a corresponding text annotation exists, the primary image database 510 contains a pointer to the location of the text in the text annotation database 514.

When the sync manager 230 is active, the imaging conduit 310 queries the primary image database 510 for new and/or different image records, which the imaging conduit 310 preferably determines by the name of the image. If a new image is found, the imaging conduit 310 reviews the image record to determine whether a corresponding color image exists, and if so, where located. The imaging conduit 310 also reviews the image record in the primary image database 510 to determine whether a text annotation for the image exists, and if so, where located. If the imaging conduit 310 determines that a corresponding color image exists, the imaging conduit 310 will preferably transfer only the color image to the computing device 110. The gray scale image may then be recreated in the computing device 110 using techniques known in the art.

When the imaging conduit 310 transfers image data to the computing device 110, the imaging conduit 310 preferably modifies the format of the image data. In one embodiment, the image data may be transformed into a JPEG format. During this transformation, the image may be further formatted into RGB for display on the color monitor of a personal computer. The JPEG images are then stored in the computer memory 220 in a directory specified by the user as part of the installation process of the imaging conduit 310 to the computing device 110. Within that directory are various subdirectories based on categories created using the imaging application 434 in the handheld electronic device 120, such as family, friends, business, etc. The imaging conduit 310 may create new subdirectories during the synchronization process based on new categories created by the user.

Images transferred to the computing device 100 by the imaging conduit 310 will preferably be stored in JPEG format in the computer memory 220 with a “.jpg” file extension. Text annotation files will have the same name as the corresponding image, but will be stored in the computer memory 220 with a “.txt” file extension. Although the transferred images are stored in the computer memory 220 as JPEG files, other image data file formats are within the scope of the present invention.

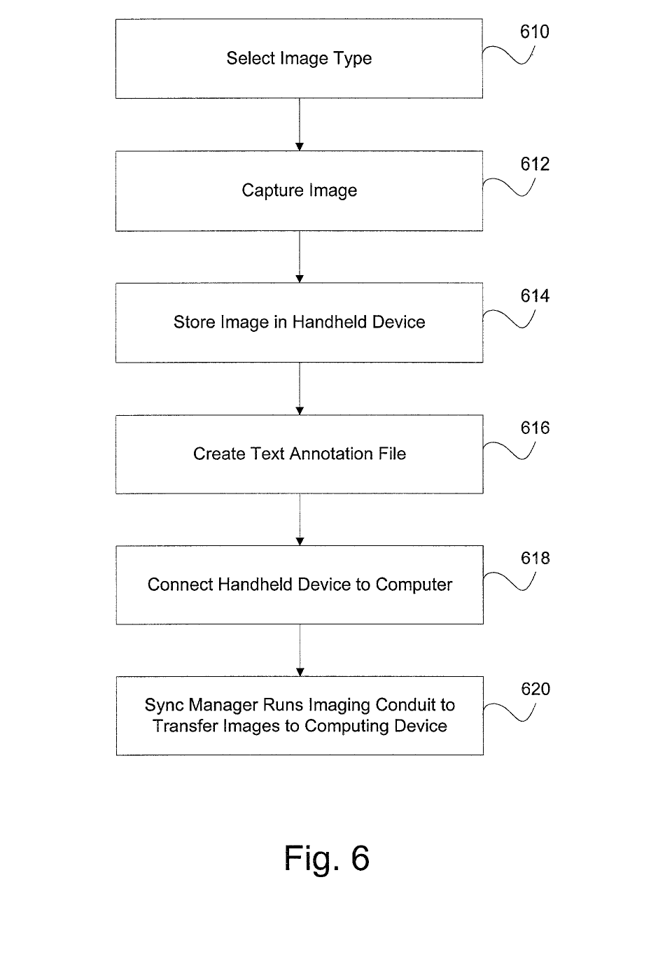

Referring now to FIG. 6, a flowchart of method steps for capturing and transferring images from a handheld electronic device is shown, according to one embodiment of the present invention. Initially, in step 610, the user of the handheld electronic device 120 selects the type of image to be captured. In the preferred embodiment, the user may choose from a color image, a high-resolution gray scale image, and a low-resolution gray scale image.

In step 612, the user captures a desired image using the image capture device 124. Next, in step 614, the captured image is stored in the handheld device memory 420 of the handheld electronic device 120. The user can preferably create a category and a title for the image. If the user so chooses, then in step 616 the user creates a text annotation file containing the caption or description information, which is saved to the handheld device memory 420 along with the image.

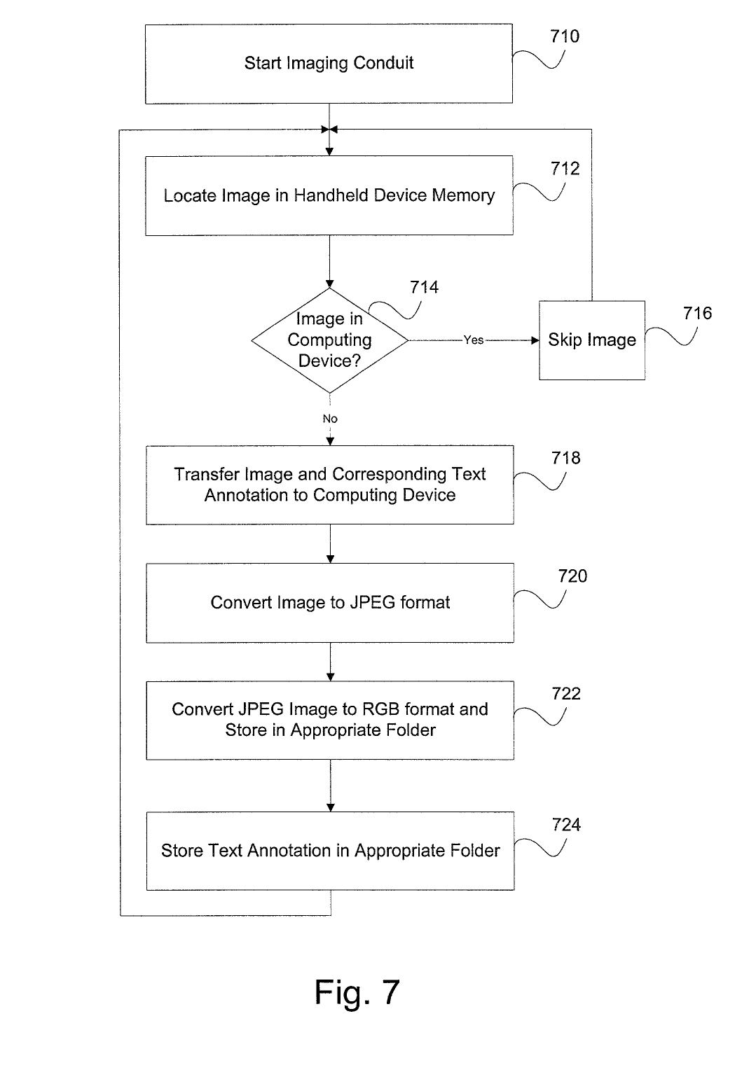

Once the desired images have been captured, the handheld electronic device 120 is connected to the computing device 110 utilizing the I/O device 122 in step 618. Then, in step 620, the sync manager 230 runs the imaging conduit 310 along with any other conduits to synchronize the handheld electronic device 120 and the computing device 110. The functionality of the imaging conduit 310 is discussed below in conjunction with FIG. 7. Although the above discussion describes transferring images from the handheld electronic device 120 to the computing device 110, a bi-directional synchronization of images, including uploading images from the computing device 110 to the handheld electronic device 120, is within the scope of the present invention.

Referring now to FIG. 7, a flowchart of method steps for seamlessly transferring images from a handheld electronic device is shown, according to one embodiment of the present invention. Initially, in step 710, the sync manager 230 starts the imaging conduit 310. In step 712, the imaging conduit 310 locates an image in the handheld device memory 420 of the handheld electronic device 120. Image data is preferably stored in the captured image data 432, as discussed above in conjunction with FIG. 5.

In step 714, the imaging conduit 310 determines whether the image exists in the computing device 110 by comparing the name of the image with the names of the images stored in the computer memory 220. If the image exists in the computer memory 220, then in step 716 the imaging conduit 310 skips that image record and locates and processes the next image in handheld device memory 420. If the image does not exist in the computer memory 220, then in step 718 the imaging conduit 310 transfers the image and any corresponding text annotation to the computing device 110. As discussed above in conjunction with FIG. 5, the imaging conduit 310 determines whether a color version of the image exists, and if so, transfers the color image only. The imaging conduit 310 also determines whether a text annotation exists for the image, and if so, transfers the annotation. If a new text annotation exists for an image stored in the computing device 110, the imaging conduit 310 will only transfer the new text annotation information.

Next, in step 720, the imaging conduit 310 preferably converts the image data into a JPEG format. In step 722, the imaging conduit 310 converts the JPEG image into an RGB format before storing the JPEG image in the appropriate folder based on the category of the image. The JPEG image is stored as a file of the name created by the user upon image capture, or by the default name of the date/time stamp.

Then, in step 724, the corresponding text annotation, if available, is stored in the same folder as the image. The text annotation file has the same name as the image file, but has an extension that identifies the file as a text file, as described above. The method then returns to step 712, where the imaging conduit 310 locates further images in the handheld device memory 420 of the handheld electronic device 120.

As preferred embodiments of the present invention are described above with reference to the aforementioned drawings, various modifications or adaptations of the methods and specific structures described may become apparent to those skilled in the art. All such modifications, adaptations, or variations that rely upon the teachings of the present invention, and through which these teachings have advanced the art, are considered to be within the spirit and scope of the present invention. Hence, these descriptions and drawings are not be considered in a limiting sense as is understood that the present invention is in no way limited to the embodiments illustrated.

What is claimed is:

1. A machine-readable medium having embodied thereon an image conduit program, the program being executable by a computing device to perform method steps for transferring and synchronizing images from an electronic device to said computing device, the method steps comprising:
locating a first image stored in a first memory of said electronic device based on a plurality of searchable image parameters of said first image;
querying a second memory of said computing device for the existence of a second image that is identical to said first image; and
transferring said first image to said second memory of said computing device if said first image is not identical to said second image.

2. The machine-readable medium of claim 1, wherein said first memory of said electronic device further comprises one or more image databases resident therein containing said image parameters of said first image.

3. The machine-readable medium of claim 2, wherein said database is a color image database for storage of color image parameters pertaining to said first image.

4. The machine-readable medium of claim 2, wherein said database is a text annotation database for storage of textual data pertaining to said first image.

5. The machine-readable medium of claim 1, further comprising the step of converting said first image to one or more image formats after transferring said first image to said second memory of said computing device.

6. The machine-readable medium of claim 1, further comprising the step of converting said first image to JPEG format after transferring said first image to said second memory of said computing device.

7. The machine-readable medium of claim 6, further comprising the step of converting said first image from JPEG format to RGB format after transferring said first image to said second memory of said computing device.

8. The machine-readable medium of claim 1, wherein said first image further comprises text data for annotation of said first image.

9. The machine-readable medium of claim 8, further comprising the step of transferring said text data to said second memory of said computing device if said first image is not identical to said second image.

10. The machine-readable medium of claim 1, wherein said electronic device is handheld.

11. The machine-readable medium of claim 10, wherein said handheld electronic device is a personal digital assistant (PDA).

12. An system for transferring and synchronizing image data files between an electronic device and a computing device, comprising:
an electronic device having an input/output device and a first memory for storing said image data files;
a computing device having an input/output interface and a second memory;
a connection means, for coupling said input/output device of said electronic device to said input/output interface of said computing device; and
a means for transferring and synchronizing said image data from said electronic device to said computing device.

13. The system of claim 12, wherein said input/output device of said electronic device is a cradle that is removably attached to said electronic device.

14. The system of claim 12, wherein said connection means is a serial bus.

15. The system of claim 12, wherein said connection means is wireless.

16. The system of claim 15, wherein said wireless connection means is infrared.

17. The system of claim 12, wherein said electronic device further comprises a capture device interface.

18. The system of claim 17, wherein said electronic device further comprises an image capture device coupled to said capture device interface for capturing live images for storage to said first memory of said electronic device.

19. The system of claim 12, wherein said electronic device is handheld.

20. The system of claim 19, wherein said handheld electronic device is a personal digital assistant (PDA).

21. A method for transferring image data from an electronic device to a computing device, comprising the steps of:
capturing a live image with an image capture device;
storing said captured image to a first memory of said electronic device;
connecting said electronic device to said computing device; and
running an imager conduit program, said imager conduit program performing method steps for transferring and synchronizing said captured image from said electronic device to said computing device, said method steps comprising,
locating said stored captured image in said first memory of said electronic device based on a plurality of searchable image parameters of said first image;
querying a second memory of said computing device for the existence of a second image that is identical to said stored captured image; and
transferring said stored captured image to said second memory of said computing device if said second image is not identical to said stored captured image.

22. The method for capturing and transferring image data of claim 21, further comprising the step of selecting from a plurality of image types to apply to said live image before capturing said live image with said image capture device.

23. The method for capturing and transferring image data of claim 21, further comprising the step of creating a text annotation file prior to storing said captured image to said first memory of said electronic device, said text annotation file to be stored with said captured image.

24. The method for capturing and transferring image data of claim 21, further comprising the step of converting said stored captured image to one or more image formats after transferring to said second memory of said computing device if said second image is not identical to said stored captured image.

25. The method for capturing and transferring image data of claim 21, wherein said electronic device is handheld.

26. The method for capturing and transferring image data of claim 25, wherein said handheld electronic device is a personal digital assistant (PDA).
